(19) United States
(12) Patent Application Publication
(10) Pub. No.: US 2026/0287396 A1
(43) Pub. Date: Sep. 24, 2026

(54) INDUCTIVE POSITION SENSOR THROTTLE ASSEMBLY

(71) Applicant: Microchip Technology Incorporated, Chandler, AZ (US)

(72) Inventors: Ajith Kumar, Chennai (IN); Vignesh Ragavendran V, Nadu (IN)

(21) Appl. No.: 19/308,147

(22) Filed: Aug. 22, 2025

(30) Foreign Application Priority Data
Mar. 20, 2025 (IN) 202541025332

(51) Int. Cl. G01D 5/20

(52) U.S. Cl. CPC G01D 5/2013

(57) ABSTRACT

A printed circuit board (PCB)-based inductive position sensor to detect a position of a throttle of a vehicle is provided. The PCB-based inductive position sensor may include a flexible PCB, a sine coil formed on the flexible PCB and configured to receive an AC signal, a cosine coil formed on the flexible PCB and configured to receive an AC signal, a sensor coil formed on the flexible PCB and configured to detect a magnetic flux differential between magnetic flux generated by the sine coil and magnetic flux generated by the cosine coil, and one or more integrated circuits (ICs) coupled to the sensor coil and configured to determine a position of the throttle based on the magnetic flux differential.

### CROSS-REFERENCE TO RELATED APPLICATION

The present application claims priority to Indian Provisional Patent Application No. 202541025332 filed on Mar. 20, 2025, which is incorporated herein by reference in its entirety.

### TECHNICAL FIELD

The present disclosure relates generally to a throttle assembly, and more specifically to an inductive position sensor throttle assembly that controls the speed of a motor vehicle.

### BACKGROUND

Conventional throttle assemblies control the acceleration and deceleration of motor vehicles, such as electric vehicles and combustion engine vehicles, by using Hall effect sensors, magnetic sensors, or mechanical throttles to determine the position of the throttle, which controls the acceleration and deceleration of the vehicle. There is a desire in the industry to improve conventional throttle assemblies to overcome the effects of static magnetic fields, enhance throttle performance in harsh climates or conditions, reduce mechanical wear and tear, and achieve a full 360° throttle rotation.

Current motor vehicles often incorporate a number of electrical components, each having their own electric field. One disadvantage of using Hall effect sensors or other magnetic sensors to determine the throttle position is that these sensors are likely to be affected by the surrounding static magnetic fields of such electrical components. This affects the degree of control of the sensors, as well as their reliability and accuracy in determining throttle position. Additionally, these sensors can experience temperature drift with fluctuations in temperature, including harsh temperatures in which a vehicle may operate. The change in a sensor's output or performance due to fluctuations in temperature can lead to inaccurate measurements, unreliable performance, and even system failure.

Moreover, mechanical throttles are exposed to dirt and debris and are prone to wear and tear. Wear and tear can lead to issues like cable stretch, binding in the linkage, and dirt/debris buildup, resulting in reduced throttle response, rough idle, and potentially a stuck accelerator or throttle (e.g., a hand grip or pedal).

Furthermore, existing technology restricts the throttle position to certain angles, often less to than 90°. This limits the applications of the sensor generally and its application in other technologies.

Given the drawbacks of conventional technologies for controlling the acceleration and deceleration of motor vehicles, various examples of the present disclosure provide an assembly that may overcome the effects of static magnetic fields, enhance throttle performance in harsh climates or conditions, and achieve a full 360° throttle position.

### SUMMARY OF VARIOUS EXAMPLES

According to various examples, an inductive position sensor throttle assembly is described herein. The inductive position sensor throttle assembly may comprise a throttle and a printed circuit board (“PCB”)-based inductive position sensor wrapped around a handlebar of a vehicle. Additionally, the PCB-based inductive position sensor may comprise a flexible PCB; a sine coil, a cosine coil, and a sensor coil formed on the flexible PCB; and one or more integrated circuits (“ICs”) coupled to the sensor coil. The sine coil and cosine coil may be configured to receive an AC signal. The sensor coil may be configured to detect a magnetic flux differential between magnetic flux generated by the sine coil and magnetic flux generated by the cosine coil. The ICs may be configured to determine the position of the throttle based on the magnetic flux differential. According to various examples, when the position of the throttle is changed, a target metal mounted to the throttle generates the magnetic flux differential that generates a current in the sensor coil. The current in the sensor coil correlates to the throttle's position. The ICs may be configured to determine the position of the throttle based on the current in the sensor coil. Additionally, the ICs may be configured to send data representing the position of the throttle to an electronic control unit configured to control the speed of the vehicle. According to various examples, the flexible PCB may include a top layer and a bottom layer. The sensor coil may be formed on the top layer. The sine and cosine coils may be alternatively formed on the top layer and the bottom layer of the flexible PCB. According to various examples, the throttle may be configured to rotate 360 degrees around the handlebar of the vehicle. According to various examples, the target metal may be made of iron, steel, aluminum, copper, or any combination thereof.

According to various examples, a PCB-based inductive position sensor to detect the position of a throttle of a vehicle is described. The PCB-based inductive position sensor may comprise a flexible PCB; a sine coil, a cosine coil, and a sensor coil formed on the flexible PCB; and one or more ICs coupled to the sensor coil. The sine coil and cosine coil may be configured to receive an AC signal. The sensor coil may be configured to detect a magnetic flux differential between magnetic flux generated by the sine coil and by the cosine coil. The ICs may be configured to determine the position of the throttle based on the magnetic flux differential. The PCB-based inductive position sensor may comprise a target metal configured to be mounted to an inner side of the throttle. When the position of the throttle is changed, the target metal generates the magnetic flux differential that generates a current in the sensor coil. The current in the sensor coil correlates to the position of the throttle. The ICs may be configured to determine the position of the throttle based on the current in the sensor coil. The ICs may be configured to send data representing the position of the throttle to an electronic control unit configured to control the speed of the vehicle. The flexible PCB may include a top layer and a bottom layer. The sensor coil is formed on the top layer. The sine and cosine coils are alternatively formed on the top layer and the bottom layer of the flexible PCB. The sine and cosine coils may be configured to generate the magnetic flux differential.

According to various examples, a method of detecting the position of a throttle of a vehicle is also described. The method may comprise providing an AC signal to a sine coil formed on a flexible PCB wrapped around a handlebar within the throttle of the vehicle. The method may further include providing an AC signal to a cosine coil formed on the flexible PCB. The method may further include detecting a magnetic flux differential between magnetic flux generated by the sine coil and magnetic flux generated by the cosine coil. The method may further include determining the position of the throttle based on the magnetic flux differential. Detecting the magnetic flux differential may be performed by a sensor coil formed on the flexible PCB. The magnetic flux differential varies based on the position of a target metal mounted to an inner side of the throttle relative to the sine and cosine coils. Detecting the position of the throttle may include detecting a current in the sensor coil. The current in the sensor coil may depend on the position of the target metal relative to the sine and cosine coils.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE FIGURES

Features, aspects, and advantages of the present disclosure are better understood when the following detailed description is read with reference to the accompanying figures, in which:

FIG. 1 shows an inductive position sensor throttle assembly according to one or more examples.

FIG. 2 shows a handlebar, PCB-based inductive position sensor, and target metal according to one more examples.

FIG. 3 shows a flexible PCB-based inductive position sensor according to one or more examples.

### DETAILED DESCRIPTION

Various aspects of the present disclosure will now be described more fully hereinafter with reference to the accompanying pictures in which various examples. However, the examples disclosed herein may be embodied in many different forms and should not be construed as limited to the representative embodiments set forth herein. The examples are provided so that this disclosure will be both thorough and complete and enable one of ordinary skill in the art to make, use, and practice one or more examples disclosed herein.

Relative terms such as lower or bottom; upper or top; upward, outward, or downward; forward or backward; and vertical or horizontal may be used herein to describe one element's relationship to another element illustrated in the figures. It will be understood that relative terms are intended to encompass different orientations in addition to the orientation depicted in the drawings. By way of example, if a component in the drawings is turned over, elements described as being on the “bottom” of the other elements would then be oriented on “top” of the other elements. Relative terminology, such as “substantially” or “about,” describe the specified materials, steps, parameters, or ranges as well as those that do not materially affect the basic and novel characteristics of the examples as whole (as would be appreciated by one of ordinary skill in the art).

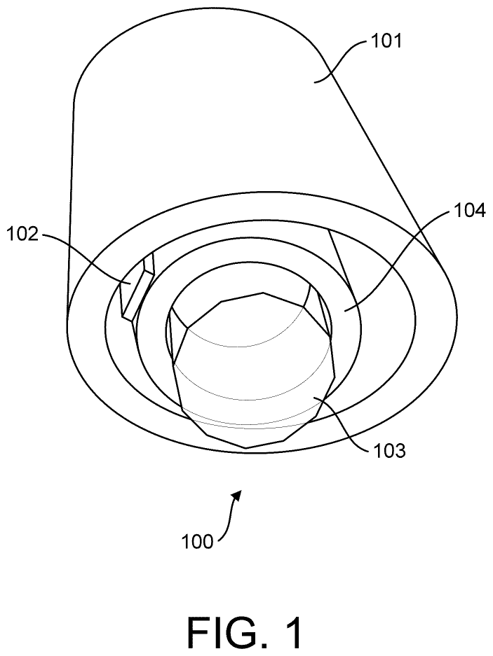

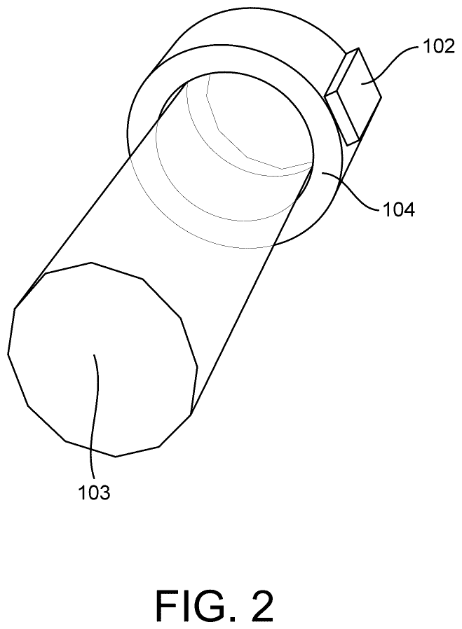

FIG. 1 shows an example inductive position sensor throttle assembly 100 comprising a throttle 101, a target metal 102 mounted to the throttle 101, a handlebar 103 configured to be connected to a vehicle, and a flexible PCB-based inductive position sensor 104 wrapped around and fixed to the handlebar 103. The throttle 101 encircles and covers the handlebar 103 and PCB-based inductive position sensor 104. FIG. 2 shows a closer view of the target metal 102 and the PCB-based inductive position sensor 104 wrapped around and fixed to the handlebar 103. The target metal 102 can be made of a variety of metals, including without limitation, iron, steel, aluminum, and copper, and any combination thereof.

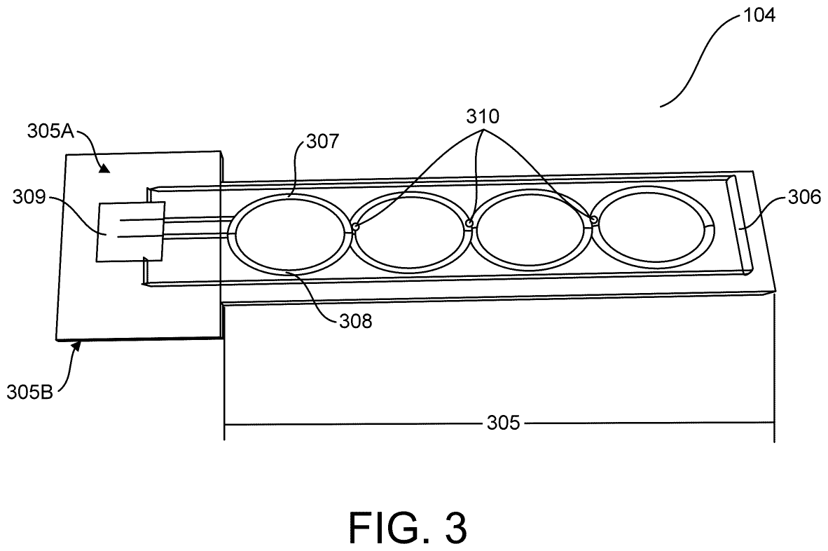

As depicted in FIG. 3, the PCB-based inductive position sensor 104 may include a flexible printed circuit board (“PCB”) 305, a sensor coil 306, a sine coil 307, and a cosine coil 308, which may be in the form of copper traces formed on the PCB 305. The sine coil 307 and cosine coil 308 may be configured to each receive an A/C signal, which generates magnetic flux when current passes through the sine coil 307 and cosine coil 308. The sine and cosine coils 307, 308 may be configured so that the magnetic flux generated by the sine coil 307 may cancel the magnetic flux generated by the cosine coil 308 in the absence of metal near the sine and cosine coils 307, 308. The PCB-based inductive position sensor 104 may be comprised of a top layer 305A and a bottom layer 305B, although PCBs with more than two layers may also be used. The sensor coil 306 may be formed on the top layer 305A of the PCB-based inductive position sensor 104 and the sine coil 307 and cosine coil 308 may be dispersed within the top and bottom layers 305A, 305B of the PCB-based inductive position sensor 104 and alternate between the layers 305A, 305B at vias 310 to avoid short circuiting. According to various examples, the sensor coil 306 may be located in a peripheral region of the top layer 305A of the PCB 305, such that the sine and cosine coils 307, 308 on the top layer 305A of the PCB 305 may be substantially surrounded by the sense coil 306. The sense coil 306 may detect a differential between the magnetic flux generated by the sine and cosine coils 307, 308. The sense coil 306 may be coupled to one or more position sense integrated circuits (ICs) 309 disposed on the flexible PCB 305, which are configured to determine the position of the target metal 102 or throttle 101 based on the magnetic flux differential sensed by the sense coil 306. The PCB-based inductive position sensor 104 may have improved accuracy over other sensors (i.e., Hall effect sensors), reduced sensitivity to magnetic noise, and may not require a magnet as a target.

As seen in FIG. 1, the throttle 101 is wrapped around the PCB-based inductive position sensor 104 and handlebar 103. The target metal 102 is attached to the side of the throttle 101 that faces inward toward the PCB-based inductive position sensor 104 and handlebar 103. According to various examples, the throttle 101 and the target metal 102 do not come into contact with the PCB-based inductive position sensor 104 and handlebar 103, thereby potentially reducing mechanical wear and tear of those components.

When the throttle 101 is rotated (e.g., by a user), the target metal 102, which is fixed to the inner side of the throttle 101, changes position in correlation. As the target metal 102 moves relative to the sine and cosine coils, the target metal 102 affects the magnetic flux in one or both of the sine and cosine coils 307, 308 to create a magnetic flux differential between the sine coil and cosine coil 307, 308, consequently generating a current in the sensor coil 306. The one or more ICs 309 disposed on the flexible PCB 305 are coupled to the sensor coil 306, and are configured to determine the position of the throttle 101 based on the current generated in the sensor coil 306. The one or more ICs 309 send the angular position of the target metal 102 or arc location data to the vehicle's electronic control unit (“ECU”) via microcontroller unit (“MCU”), which controls the speed of the motor or engine.

The example assembly described herein may offer significant advantages over existing Hall effect and other magnetic sensors. While the example assembly has been applied to motor vehicles, the PCB-based inductive position sensor may measure linear and angular/rotation movement found in a variety of automotive, industrial, aerospace and commercial applications.

The example assembly may provide solutions for reliable automotive position sensor applications, such as automobile throttle body, transmission gear sensing, electronic power steering and accelerator pedals. The assembly according to various examples may give accurate position measurements, may have reduced sensitivity to stray or static magnetic fields, and may not need an external magnetic device. Further, the sensors may offer full rotation of the throttle, have limited mechanical wear and tear, and are suitable for harsh temperatures and environments.

Additionally, the inductive position sensor enables lighter, smaller, more reliable motor control solutions, reduces overall system costs, and operates seamlessly and precisely in the noisy environment of an automobile's DC motors, high currents, and solenoids. Furthermore, the assembly is simple to install and implement in older systems. Such features provide the overall assembly with commercial advantages over current technologies.

Although the foregoing description provides various examples, it is envisioned that other examples may perform similar functions and/or achieve similar results. Any and all such equivalent examples are within the scope of the present disclosure.

It will be appreciated by persons skilled in the art that the examples described herein are not limited to what has been particularly shown and described herein above. In addition, unless mention was made above to the contrary, the accompanying drawings are not to scale. A variety of modifications and variations are possible in light of the above teachings.

What is claimed is:

1. An inductive position sensor throttle assembly, comprising:
(a) a throttle; and
(b) a printed circuit board (PCB)-based inductive position sensor wrapped around a handlebar of a vehicle, the PCB-based inductive position sensor comprising:
(i) a flexible PCB;
(ii) a sine coil formed on the flexible PCB and configured to receive an AC signal;
(iii) a cosine coil formed on the flexible PCB and configured to receive an AC signal;
(iv) a sensor coil formed on the flexible PCB and configured to detect a magnetic flux differential between magnetic flux generated by the sine coil and magnetic flux generated by the cosine coil; and
(v) one or more integrated circuits (ICs) coupled to the sensor coil and configured to determine a position of the throttle based on the magnetic flux differential.

2. The inductive position sensor throttle assembly of claim 1, wherein when a position of the throttle is changed, a target metal mounted to the throttle generates the magnetic flux differential that generates a current in the sensor coil.

3. The inductive position sensor throttle assembly of claim 2, wherein the current in the sensor coil correlates to the throttle's position.

4. The inductive position sensor throttle assembly of claim 3, wherein the one or more ICs are configured to determine the position of the throttle based on the current in the sensor coil.

5. The inductive position sensor throttle assembly of claim 4, wherein the one or more ICs are configured to send data representing the position of the throttle to an electronic control unit configured to control a speed of the vehicle.

6. The inductive position sensor throttle assembly of claim 1, wherein the flexible PCB includes a top layer and a bottom layer, and wherein the sensor coil is formed on the top layer.

7. The inductive position sensor throttle assembly of claim 6, wherein the sine and cosine coils are alternatively formed on the top layer and the bottom layer of the flexible PCB.

8. The inductive position sensor throttle assembly of claim 1, wherein the throttle is configured to rotate 360 degrees around the handlebar of the vehicle.

9. The inductive position sensor throttle assembly of claim 1, wherein the target metal is made of iron, steel, aluminum, copper, or any combination thereof.

10. A printed circuit board (PCB)-based inductive position sensor to detect a position of a throttle of a vehicle, the PCB-based inductive position sensor comprising:
(a) a flexible PCB;
(b) a sine coil formed on the flexible PCB and configured to receive an AC signal;
(c) a cosine coil formed on the flexible PCB and configured to receive an AC signal;
(d) a sensor coil formed on the flexible PCB and configured to detect a magnetic flux differential between magnetic flux generated by the sine coil and magnetic flux generated by the cosine coil; and
(e) one or more integrated circuits (ICs) coupled to the sensor coil and configured to determine a position of the throttle based on the magnetic flux differential.

11. The PCB-based inductive position sensor of claim 10, comprising:
(a) a target metal configured to be mounted to an inner side of the throttle;
wherein when a position of the throttle is changed, the target metal generates the magnetic flux differential that generates a current in the sensor coil.

12. The PCB-based inductive position sensor of claim 11, wherein the current in the sensor coil correlates to the position of the throttle.

13. The PCB-based inductive position sensor of claim 12, wherein the one or more ICs are configured to determine the position of the throttle based on the current in the sensor coil.

14. The PCB-based inductive position sensor of claim 13, wherein the one or more ICs are configured to send data representing the position of the throttle to an electronic control unit configured to control a speed of the vehicle.

15. The PCB-based inductive position sensor of claim 10, wherein the flexible PCB includes a top layer and a bottom layer, and wherein the sensor coil is formed on the top layer.

16. The PCB-based inductive position sensor of claim 15, wherein the sine and cosine coils are alternatively formed on the top layer and the bottom layer of the flexible PCB, and configured to generate the magnetic flux differential.

17. A method of detecting a position of a throttle of a vehicle, the method comprising:
(a) providing an AC signal to a sine coil formed on a flexible printed circuit board (PCB) wrapped around a handlebar within the throttle of the vehicle;
(b) providing an AC signal to a cosine coil formed on the flexible PCB;
(c) detecting a magnetic flux differential between magnetic flux generated by the sine coil and magnetic flux generated by the cosine coil;
(d) determining a position of the throttle based on the magnetic flux differential.

18. The method of claim 17, wherein the detecting the magnetic flux differential is performed by a sensor coil formed on the flexible PCB; and
wherein the magnetic flux differential varies based on a position of a target metal mounted to an inner side of the throttle relative to the sine and cosine coils.

19. The method of claim 18, wherein the detecting the position of the throttle includes detecting a current in the sensor coil.

20. The method of claim 19, wherein the current in the sensor coil depends on the position of the target metal relative to the sine and cosine coils.
